(19) United States
(12) Patent Application Publication
(10) Pub. No.: US 2025/0282546 A1
(43) Pub. Date: Sep. 11, 2025

(54) ROBOT AND WAREHOUSING SYSTEM

(71) Applicant: HAI ROBOTICS CO., LTD., Shenzhen (CN)

(72) Inventor: Qingxin Zhan, Shenzhen (CN)

(21) Appl. No.: 19/220,280

(22) Filed: May 28, 2025

Related U.S. Application Data
(63) Continuation of application No. PCT/CN2023/134118, filed on Nov. 24, 2023.

(30) Foreign Application Priority Data
Dec. 30, 2022 (CN) 202211741129.9

(51) Int. Cl. B65G 1/04; B66F 9/07; B66F 9/12; B66F 9/18

(52) U.S. Cl. CPC B65G 1/0435; B66F 9/07; B66F 9/122; B66F 9/181

(57) ABSTRACT

This application provides a robot and a warehousing system. The robot is configured to take or place a goods container which includes a robot body and a fork apparatus. The fork apparatus is arranged on the robot body which includes a telescopic mechanism and a goods retrieval mechanism. The telescopic mechanism includes a base plate and a transmission assembly. The goods retrieval mechanism is connected to the transmission assembly to move along a length direction of the base plate under the drive of the transmission assembly. The goods retrieval mechanism includes a rotating unit, a connecting base, and a goods retrieval unit. The goods retrieval unit is arranged on the connecting base. The rotating unit is configured to drive the connecting base to rotate relative to the telescopic mechanism, so that the goods retrieval unit can take or place the goods container in a different direction of the fork apparatus.

### CROSS-REFERENCES

This application is a continuation of International Patent Application No. PCT/CN2023/134118 filed on Nov. 24, 2023, which claims priority to Chinese Patent Application No. 202211741129.9, filed with the China National Intellectual Property Administration on Dec. 30, 2022 and entitled “ROBOT AND WAREHOUSING SYSTEM”, which is incorporated herein by reference in its entirety.

### TECHNICAL FIELD

This application relates to the field of warehousing and logistics technologies, and in particular, to a robot and a warehousing system.

### BACKGROUND OF THE INVENTION

With the development of artificial intelligence and automation technologies, robots are widely used in the field of warehousing and logistics for taking, placing, transporting, and sorting goods. In a logistics system, goods are usually stored in a shelving unit, and a robot with a corresponding function takes or places goods or completes a goods transport task by docking with the shelving unit or a conveyor.

In the related art, a robot for taking or placing goods may move on an aisle between shelving units. The robot is usually provided with a fork for taking or placing goods. The fork is usually provided with a manipulator that is stretchable in a fixed direction relative to a robot body, and the whole fork may rotate relative to the robot body. The manipulator usually completes an operation of taking or placing goods on a lateral side of the robot along a forward direction. Therefore, when the robot completes a task to take or place goods from or on a shelving unit on a different side, the fork needs to be rotated to reverse an orientation of the fork.

However, the manipulator on the robot for taking goods can only take or place goods in a single direction of the fork. During retrieval or storage of goods in a different direction, the orientation of the fork or the robot needs to be reversed as a whole, resulting in an increase in a width of an aisle between adjacent shelving units, and a reduction in a warehousing density.

### SUMMARY OF THE INVENTION

This application provides a robot and a warehousing system, to resolve a problem of a reduction in a warehousing density of the warehousing system as a result of a goods retrieval or storage structure of the robot.

According to a first aspect, this application provides a robot for taking or placing a goods container. The robot includes a robot body and a fork apparatus. The fork apparatus is arranged on the robot body. The fork apparatus includes a telescopic mechanism and a goods retrieval mechanism. The telescopic mechanism includes a base plate and a transmission assembly. The goods retrieval mechanism is connected to the transmission assembly to move along a length direction of the base plate under the drive of the transmission assembly. The goods retrieval mechanism includes a rotating unit, a connecting base, and a goods retrieval unit. The goods retrieval unit is arranged on the connecting base. The rotating unit is configured to drive the connecting base to rotate relative to the telescopic mechanism, so that the goods retrieval unit can take or place the goods container in a different direction of the fork apparatus.

In the robot provided in this embodiment of this application, the transmission assembly is arranged to drive the goods retrieval mechanism to move relative to a telescopic plate, so that the goods retrieval mechanism may take or place the goods container. The goods retrieval mechanism is configured to cause the goods retrieval unit to have different orientations relative to the fork apparatus through a rotating assembly, so that the goods retrieval mechanism may take or place the goods container in the different direction of the fork apparatus with the telescopic mechanism.

In an optional implementation, in operation of the transmission assembly, the goods retrieval mechanism is configured to drive the telescopic plate to stretch bidirectionally relative to the base plate along the length direction of the base plate. The telescopic plate is driven through the goods retrieval mechanism to stretch bidirectionally relative to the base plate, so that the fork apparatus may also complete goods retrieval operations in forward and backward directions without rotating, thereby reducing a footprint of the fork apparatus, reducing a spacing between the shelving units in the warehousing system, and increasing the warehousing density.

In an optional implementation, the transmission assembly may include a locking mechanism, a flexible transmission member, and a transmission wheel set. The transmission wheel set includes a plurality of transmission wheels. The plurality of transmission wheels are respectively located on the base plate and the telescopic plate. The flexible transmission member is wrapped around the plurality of transmission wheels, and moves with rotation of the transmission wheel. The locking mechanism is connected between the base plate and the telescopic plate. When the locking mechanism is unlocked, the transmission wheels drive the base plate and the telescopic plate to move relative to each other under the drive of the flexible transmission member.

Through such arrangement, in operation, the transmission assembly may drive the goods retrieval mechanism or the telescopic plate into movement based on a locked state of the locking mechanism, thereby completing the stretching or retracting and the operation of taking or placing goods.

In an optional implementation, the transmission assembly may further include a first driving unit. The first driving unit is connected to each of the transmission wheels and configured to drive the transmission wheel to rotate.

Through such arrangement, through forward driving and reverse driving of the first driving unit, the telescopic plate can stretch bidirectionally.

In an optional implementation, the fork apparatus may further include a sliding plate slidably arranged on the telescopic plate. The goods retrieval mechanism is connected to the sliding plate, and the sliding plate is connected to the flexible transmission member and is configured to move with the flexible transmission member.

Through such arrangement, the flexible transmission member may be connected to the goods retrieval mechanism through the sliding plate, and smoothness of the movement of the goods retrieval mechanism relative to the telescopic plate is ensured.

In an optional implementation, the transmission wheels on the telescopic plate have a variable relative position relative to the transmission wheels on the base plate, so that the flexible transmission member can drive the telescopic plate to stretch or retract relative to the base plate during the movement.

Through such arrangement, through the transmission of the flexible transmission member, in a case that a single driving source is used, relative movement between the telescopic plate and the base plate may be realized, and relative movement between the sliding plate and the telescopic plate may also be realized.

In an optional implementation, the plurality of transmission wheels include two transmission wheel sets arranged symmetrically. Each of the transmission wheel sets includes a first transmission wheel, a second transmission wheel, and a third transmission wheel. The first transmission wheel and the second transmission wheel are arranged on the telescopic plate, the third transmission wheel is arranged on the base plate, and the first transmission wheel and the third transmission wheel have different positions in a movement direction of the telescopic plate. A flexible transmission belt is wrapped around the first transmission wheel and the third transmission wheel in the two transmission wheel sets, to form a closed ring, and the second transmission wheels in the two transmission wheel sets are both located outside the closed ring.

Through such arrangement, when the telescopic plate moves relative to the base plate, a formed annular contour of the flexible transmission member may provide a stroke space for a relative position change of the transmission wheels on the telescopic plate and the base plate.

In an optional implementation, the telescopic plate and the base plate may extend along a same direction. Two ends of the telescopic plate are each provided with an abutting portion. When the sliding plate abuts against the abutting portion, the flexible transmission member is configured to push the telescopic plate to move through the sliding plate.

Through such arrangement, a limit may be provided for the movement of the sliding plate relative to the telescopic plate, and the sliding plate may drive the telescopic plate to move by abutting against the abutting portion.

In an optional implementation, the two transmission wheel sets are symmetrically distributed along a movement direction of the telescopic plate, and a spacing between two second transmission wheels in the two transmission wheel sets is less than a spacing between two first transmission wheels.

Through such arrangement, it is ensured that the telescopic plate has a sufficient stroke of stretching or retracting relative to the base plate, and strokes of the telescopic plate stretching bidirectionally relative to the base plate are symmetrical.

In an optional implementation, in operation of the flexible transmission member in a first direction, the telescopic plate is configured to stretch from a first end of the base plate, or the telescopic plate is configured to retract from a second end of the base plate. In operation of the flexible transmission member in a second direction, the telescopic plate is configured to stretch from the second end of the base plate, or the telescopic plate is configured to retract from the first end of the base plate.

In an optional implementation, the telescopic mechanism may further include a first sliding rail and a second sliding rail. The first sliding rail is arranged between the base plate and the telescopic plate, and the first sliding rail is configured to extend along the length direction of the base plate. The second sliding rail is arranged on the telescopic plate, the second sliding rail is configured to extend along a length direction of the telescopic plate, and the sliding plate is configured to move along the second sliding rail.

Through such arrangement, smoothness of movement of the telescopic plate and the sliding plate may be ensured.

In an optional implementation, two telescopic mechanisms may be arranged. The fork apparatus may further include a tray, a connecting bracket, and a transmission shaft. The two telescopic mechanisms are symmetrically distributed on two sides of the tray. Telescopic plates of the two telescopic mechanisms are respectively connected to the two sides of the tray, and base plates of the two telescopic mechanisms are connected through the connecting bracket. Two ends of the sliding plate are respectively slidably connected to the telescopic plates of the two telescopic mechanisms. The first driving unit is arranged between the two telescopic mechanisms, an output end of the first driving unit is connected to the transmission shaft, and two ends of the transmission shaft are respectively connected to the transmission wheels of the two telescopic mechanisms.

Through such arrangement, a reasonable layout of an overall structure of the fork apparatus may be ensured, thereby increasing a space utilization rate, and the symmetrically distributed telescopic mechanisms cause movement of the tray to be stable and reliable.

In an optional implementation, two ends of the tray along a stretching or retraction direction of the telescopic plate are each provided with a buffer pad.

Through such arrangement, when the telescopic plate is docked with an external shelving unit, the buffer pad may act as a buffer to avoid rigid impact.

In an optional implementation, the locking mechanism may be arranged on the base plate, the locking mechanism includes a locking member, the telescopic plate is provided with a positioning groove, and the locking member is insertable into the positioning groove or detachable from the positioning groove, to lock or unlock the telescopic plate and the base plate.

Through such arrangement, the reliability of the locking and unlocking process of the telescopic plate relative to the base plate may be ensured, to avoid loose locking or jamming.

In an optional implementation, the locking mechanism may further include a first elastic member, the locking member is slidably arranged on the base plate, and the locking member is provided with a hanging pin. A first end of the first elastic member is connected to the hanging pin, a second end of the first elastic member is connected to the base plate, and the first elastic member is configured to apply an elastic force toward the positioning groove to the locking member.

Through such arrangement, the reliability of the locked state of the locking member may be maintained through the elastic force provided by the first elastic member.

In an optional implementation, the locking mechanism may further include a second driving unit, an output end of the second driving unit is provided with a rocker arm, and the second driving unit is configured to drive the rocker arm to rotate. The locking member is provided with a stop pin. When the rocker arm is in a first position, the rocker arm is configured to abut against the stop pin to disengage the locking member from the positioning groove. When the rocker arm is in a second position, the rocker arm is detached from the stop pin, and the locking member is engaged with the positioning groove under the elastic force of the first elastic member.

Through such arrangement, active locking and unlocking of the locking mechanism may be implemented, improving efficiency of movement of the locking member.

In an optional implementation, an end of the locking member facing the positioning groove is provided with a roller, two opposite sides of the positioning groove along the movement direction of the telescopic plate are each provided with a guide surface, and the guide surfaces on two sides of the positioning groove are both inclined toward the positioning groove, to guide the roller to roll.

Through such arrangement, guidance may be provided for the roller when the roller slides out of the positioning groove.

In an optional implementation, the fork apparatus may further include a reset mechanism. The reset mechanism may include a reset baffle, a second elastic member, and a third elastic member. The reset baffle is connected to the base plate. The second elastic member and the third elastic member are both arranged on the telescopic plate. The second elastic member and the third elastic member are both configured to abut against the reset baffle, and when the telescopic plate stretches relative to the base plate, one of the second elastic member and the third elastic member is configured to apply an elastic force toward the retraction direction of the telescopic plate to the telescopic plate.

Through such arrangement, when the telescopic plate needs to retract after stretching or retracting relative to the base plate, the reset mechanism provides the elastic force to realize quick reset.

In an optional implementation, the reset mechanism may further include a guide shaft. The guide shaft is arranged on the telescopic plate, and the guide shaft is configured to extend along the stretching or retraction direction of the telescopic plate. The second elastic member and the third elastic member are both sleeved on the guide shaft and arranged along an extension direction of the guide shaft. The reset baffle is located between the second elastic member and the third elastic member.

Through such arrangement, guidance may be provided for compression and rebound of the second elastic member and the third elastic member, thereby ensuring that a direction of the provided elastic force is consistent with the retraction direction of the telescopic plate.

In an optional implementation, the fork apparatus may further include a detection assembly. The detection assembly may include a controller, a sensing plate, and two first detection units. The first detection units are both arranged on the sliding plate, and each of the first detection units is electrically connected to the controller. The sensing plate is arranged on the telescopic plate, and the sensing plate is configured to extend along the length direction of the telescopic plate. The first detection unit is configured to feed back a detection signal when being opposite to the sensing plate, and the controller is configured to determine a position of the sliding plate relative to the telescopic plate based on the detection signal.

Through such arrangement, a state of stretching or retracting of the telescopic plate relative to the base plate in a different direction may be accurately determined.

In an optional implementation, the sensing plate may include a first sensing section and two second sensing sections respectively connected to two opposite ends of the first sensing section. The first sensing section is configured to pass through a midpoint of the sensing plate in the length direction, and the two second sensing sections are arranged in a staggered manner relative to a width direction of the telescopic plate. The two first detection units are arranged in a staggered manner in the width direction of the telescopic plate.

Through such arrangement, during movement of the sliding plate, one of the two first detection units is opposite to the second sensing section, or the two first detection units are both opposite to the first sensing section, thereby determining whether the telescopic plate is in a neutral position.

In an optional implementation, the goods retrieval unit may include a mounting plate and a plurality of suction cups. The mounting plate is connected to the connecting base, the mounting plate is vertically arranged, and the plurality of suction cups are arranged in an array on the mounting plate.

Through such arrangement, the telescopic plate may be prevented from entering an interior of a location of a warehouse, and a container spacing during storage of the goods container may be reduced, thereby increasing a storage density.

In an optional implementation, the goods retrieval unit may include a mounting plate and an insert plate. The insert plate is arranged on the mounting plate, the insert plate is movable relative to the mounting plate, and the insert plate is insertable into a handle groove of the goods container.

Through such arrangement, the telescopic plate may be prevented from entering an interior of a location of a warehouse, and a container spacing during storage of the goods container may be reduced, thereby increasing a storage density.

In an optional implementation, the robot may further include at least two second detection units. The at least two second detection units are respectively arranged on two ends of the fork apparatus, to detect the goods container in a different goods retrieval or placing direction of the fork apparatus.

Through such arrangement, the location and information about the goods container may be accurately identified during retrieval or storage of the goods container.

In an optional implementation, the robot may further include a lifting mechanism. The robot body may include a chassis and a stand, the stand may be arranged on the chassis, the fork apparatus is connected to the lifting mechanism, and the lifting mechanism is configured to move along a height direction of the stand.

Through such arrangement, the fork apparatus may perform an operation of taking or placing goods in positions at different heights.

According to a second aspect, this application provides a warehousing system, including a shelving unit and a robot in any of the foregoing technical solutions. A plurality of shelving units may be arranged. The plurality of shelving units are arranged at intervals. An aisle is arranged between adjacent shelving units. A width of the aisle is configured to match a width of the robot. The robot is configured to move in the aisle, and the fork apparatus of the robot is stretchable bidirectionally along a width direction of the aisle, to take or place a goods container on each of the shelving units on two sides of the aisle.

In an optional implementation, the shelving unit has a plurality of warehousing layers, and the plurality of warehousing layers are arranged along a height direction of the shelving unit. The plurality of warehousing layers include at least one transfer layer. The transfer layer is located at a bottom of the shelving unit. The robot is configured to take or place the goods container between the transfer layer and a different warehousing layer. The warehousing system may further include a transfer device. The transfer device is configured to take or place the goods container from or on the transfer layer.

In addition to the technical problems resolved through the embodiments of this application described above, the technical features constituting the technical solutions, and the beneficial effects brought about by the technical features of these technical solutions, other technical problems that can be resolved through the robot and the warehousing system provided in the embodiments of this application, other technical features included in the technical solutions, and the beneficial effects brought about by these technical features are to be further described in detail in detailed description.

### BRIEF DESCRIPTION OF DRAWINGS

To describe the technical solutions in the embodiments of this application or in the prior art more clearly, the following briefly describes the accompanying drawings required for describing the embodiments or the prior art. Apparently, the accompanying drawings in the following description show some embodiments of this application, and a person of ordinary skill in the art may still derive other drawings from these accompanying drawings without creative efforts.

FIG. 1 is a schematic diagram of an application scenario of a robot according to an embodiment of this application.

FIG. 2 is a schematic structural diagram of a robot according to an embodiment of this application.

FIG. 3 is a schematic structural diagram of a fork apparatus in a robot according to an embodiment of this application.

FIG. 4 is a schematic structural diagram of a fork apparatus in a robot according to an embodiment of this application from another perspective.

FIG. 5 is a schematic diagram of a fork apparatus in a robot according to an embodiment of this application in a stretched state.

FIG. 6 is a schematic diagram of arrangement of a telescopic mechanism of a fork apparatus in a robot according to an embodiment of this application.

FIG. 7 is an axial side view of a telescopic mechanism of a fork apparatus in a robot according to an embodiment of this application.

FIG. 8 is a schematic diagram of a telescopic mechanism of a fork apparatus in a robot according to an embodiment of this application stretching toward a front end.

FIG. 9 is a schematic diagram of a telescopic mechanism of a fork apparatus in a robot according to an embodiment of this application stretching toward a rear end.

FIG. 10 is a schematic diagram of a fork apparatus bearing a goods container in a robot according to an embodiment of this application.

FIG. 11 is a schematic diagram of a locking mechanism of a fork apparatus in a robot according to an embodiment of this application.

FIG. 12 is a schematic diagram of unlocking a locking mechanism of a fork apparatus in a robot according to an embodiment of this application.

FIG. 13 is a schematic diagram of a rocker arm of a locking mechanism of a fork apparatus in a robot according to an embodiment of this application in a first position.

FIG. 14 is a schematic diagram of a rocker arm of a locking mechanism of a fork apparatus in a robot according to an embodiment of this application in a second position.

FIG. 15 is a schematic structural diagram of a reset mechanism of a fork apparatus in a robot according to an embodiment of this application.

FIG. 16 is a schematic diagram of a reset mechanism when a fork apparatus in a robot according to an embodiment of this application is in a stretched state.

FIG. 17 is a schematic diagram of a detection assembly of a fork apparatus in a robot according to an embodiment of this application.

FIG. 18 is a schematic diagram of a first goods retrieval mechanism of a fork apparatus in a robot according to an embodiment of this application.

FIG. 19 is a schematic diagram of a first goods retrieval mechanism of a fork apparatus in a robot according to an embodiment of this application from another perspective.

FIG. 20 is a schematic diagram of arrangement of a second detection unit of a fork apparatus in a robot according to an embodiment of this application.

FIG. 21 is a schematic diagram of a second goods retrieval mechanism of a fork apparatus in a robot according to an embodiment of this application.

FIG. 22 is a schematic diagram of a second goods retrieval mechanism of a fork apparatus in a robot according to an embodiment of this application from another perspective.

FIG. 23 is a schematic diagram of a robot transferring a goods container according to an embodiment of this application.

FIG. 24 is a schematic diagram of a first state of a robot according to an embodiment of this application during goods retrieval.

FIG. 25 is a schematic diagram of a second state of a robot according to an embodiment of this application during goods retrieval.

FIG. 26 is a schematic diagram of a third state of a robot according to an embodiment of this application during goods retrieval.

### DESCRIPTION OF REFERENCE NUMERALS

100—Robot; 110—Robot body; 111—Chassis; 112—Stand; 120—Fork apparatus; 121—Telescopic mechanism; 1211—Base plate; 1212—Telescopic plate; 1212a—Abutting portion; 1212b—Positioning groove; 1212c—Guide surface; 1213—Transmission assembly; 1213a—First transmission wheel; 1213b—Second transmission wheel; 1213c—Third transmission wheel; 1214—Flexible transmission member; 1215—First driving unit; 1216—First sliding rail; 1217—Second sliding rail; 122—Goods retrieval mechanism; 1221—Sliding plate; 1222—Rotating unit; 1223—Connecting base; 1224—Goods retrieval unit; 1224a—Suction cup; 1224b—Insert plate; 123—Locking mechanism; 1231—Locking member; 1231a—Roller; 1232—First elastic member; 1233—Hanging pin; 1234—Second driving unit; 1234a—Rocker arm; 1235—Stop pin; 124—Tray; 1241—Buffer pad; 125—Connecting bracket; 126—Transmission shaft; 127—Reset mechanism; 1271—Reset baffle; 1272—Second elastic member; 1273—Third elastic member; 1274—Guide shaft; 128—Detection assembly; 1281—Sensing plate; 1281a—First sensing section; 1281b—Second sensing section; 1282—First detection unit; 129—Second detection unit; 130—Lifting mechanism;
200—Shelving unit; 201—Aisle; 210—Warehousing layer;
300—Goods container; and 301—Handle groove.

### DETAILED DESCRIPTION

In order to make objectives, technical solutions, and advantages of embodiments of this application clearer, the technical solutions in the embodiments of this application are to be clearly and completely described below with reference to the accompanying drawings in the embodiments of this application. Apparently, the embodiments to be described are a part rather than all of the embodiments of this application. All other embodiments obtained by a person of ordinary skill in the art based on the embodiments of this application without creative efforts fall within the protection scope of this application.

First, it should be understood by a person skilled in the art that these implementations are merely used for explaining the technical principles of this application, and are not intended to limit the protection scope of this application. A person skilled in the art may make corresponding adjustment to the implementations as required to adapt to specific application scenarios.

Next, it should be noted that in the description of this application, directions or position relationships indicated by the terms such as “up”, “down”, “left”, “right”, “front”, “rear”, “inside”, and “outside” are based on direction or position relationships shown in the accompanying drawings, and are merely used for ease of description, rather than indicating or implying that the apparatus or component needs to have a particular orientation or be constructed and operated in a particular orientation. Therefore, such terms should not be construed as a limitation on this application.

In the description of this specification, the description of reference terms such as “one embodiment”, “some embodiments”, “an exemplary embodiment”, “an example”, “a specific example”, or “some examples” means that specific features, structures, materials, or characteristics described based on the embodiment or example are included in at least one embodiment or example of the present disclosure. In this specification, exemplary descriptions of the foregoing terms do not necessarily refer to the same embodiment or example. In addition, the described specific features, structures, materials, or characteristics may be combined in a proper manner in any one or more of the embodiments or examples.

Various types of robots are widely used in various fields such as industry and life, and robots play an important role in industries such as transportation and logistics. In a warehousing and logistics systems, goods are usually stored in shelving units, and robots take or place goods by docking with the shelving units or conveyors, and may transport goods. A robot for taking or placing goods may move on an aisle between shelving units. The robot is usually provided with a fork for taking or placing goods. The fork is usually provided with a manipulator that is stretchable in a fixed direction relative to a robot body, and the whole fork may rotate relative to the robot body. The manipulator usually completes an operation of taking or placing goods on a side of the robot along a forward direction. Therefore, when the robot completes a task to take or place goods from or on a shelving unit on a different side, the fork needs to be rotated to reverse an orientation of the fork.

Therefore, in the related art, if a transport robot needs to dock with another device when performing a goods transport task, it needs to be ensured that the robot is opposite to the another device along a lateral side in a forward direction. The robot first needs to rotate a position of the fork when performing an operation of taking or placing goods from a different side of the robot, so that a goods retrieval direction of the fork is opposite to a target shelving unit, so as to take or place goods through stretching or retraction, resulting in relatively low efficiency of goods retrieval or storage by the robot. Second, the fork of the robot has a certain rotation diameter. In order to provide space for the rotation of the fork, a width of the aisle between adjacent shelving units needs to be increased, resulting in a reduction in a warehousing density and reducing an overall space utilization rate of a warehousing system.

In view of the above problem, the embodiments of this application provide a robot and a warehousing system. Through the structural design of the fork apparatus on the transport robot, the fork apparatus is stretchable bidirectionally in forward and backward directions, so that when the robot is on the aisle, the robot can complete the task of taking or placing goods on both sides without rotating to adjust a posture of the fork, and the aisle between the shelving units does not need to reserve space for the transport robot to rotate, which reduces the width of the aisle, and improves the space utilization rate and the warehousing efficiency.

For ease of understanding, application scenarios of a robot provided in the embodiments of this application are described first.

The robot provided in this embodiment is applied to a warehousing and logistics system for taking or placing goods. The robot may be applied to different fields such as logistics and distribution of industrial production lines, retrieval or storage of inventory products in the manufacturing industry, retrieval or storage of products in the retail industry, or retrieval or storage of parcels in e-commerce logistics. In addition, products or goods to be transported may be industrial parts, electronic accessories or products, medicines, clothing accessories, food, books, or the like. Moreover, the robot may directly transfer goods, or may transfer a goods container loaded with goods, which is not specifically limited in the embodiments of this application. A “goods container” is used to refer to a transported object of the transport robot below, and no specific examples are given.

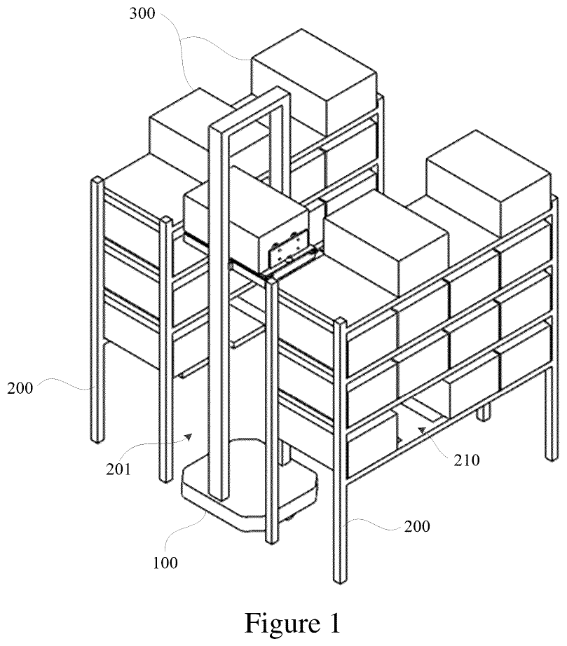

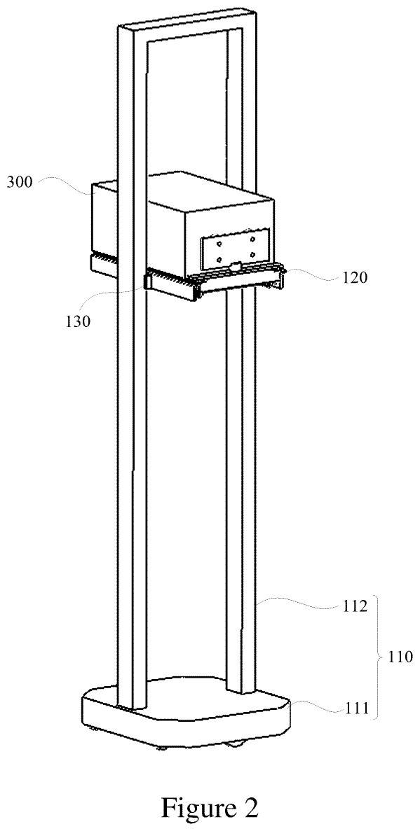

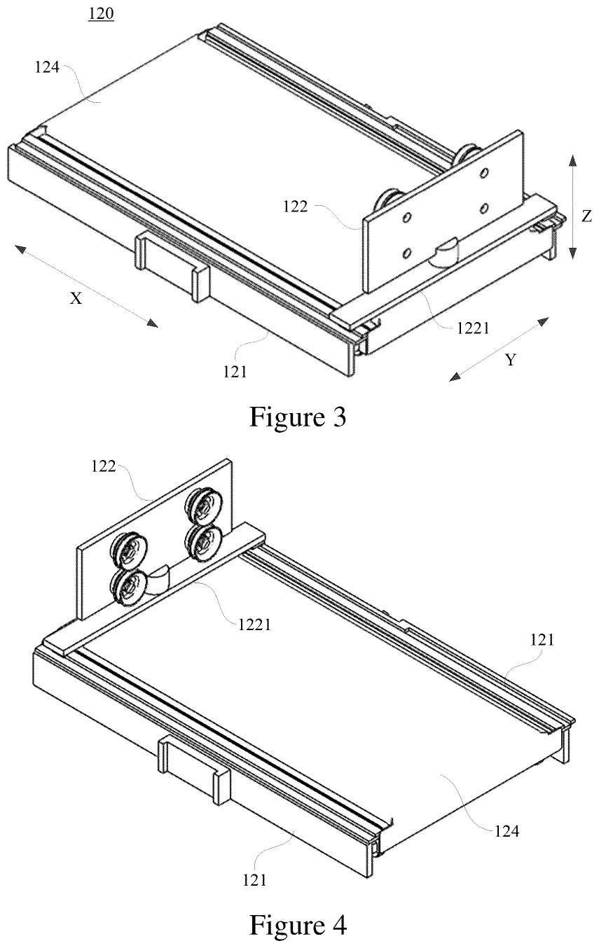

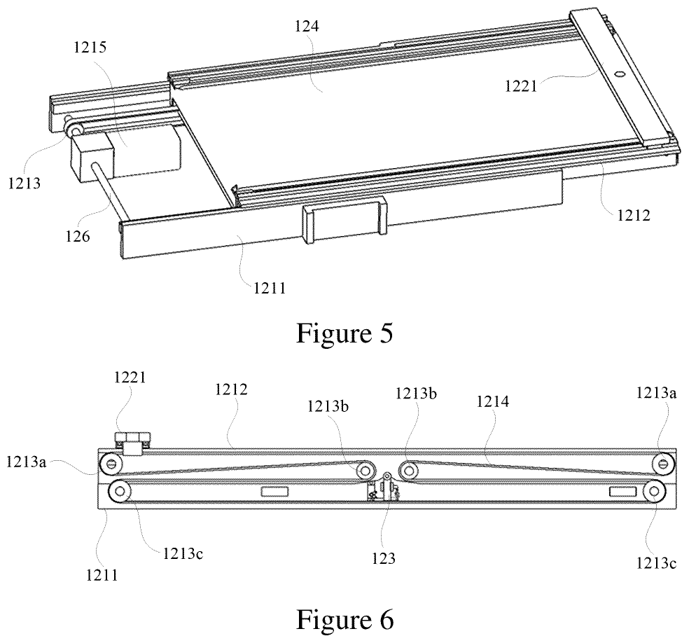

FIG. 1 is a schematic diagram of an application scenario of a robot according to an embodiment of this application, FIG. 2 is a schematic structural diagram of a robot according to an embodiment of this application, FIG. 3 is a schematic structural diagram of a fork apparatus in a robot according to an embodiment of this application, FIG. 4 is a schematic structural diagram of a fork apparatus in a robot according to an embodiment of this application from another perspective, and FIG. 5 is a schematic diagram of a fork apparatus in a robot according to an embodiment of this application in a stretched state.

As shown in FIG. 1 to FIG. 5, a robot 100 provided in the embodiments is applied to a warehousing system, and may move between shelving units 200 of the warehousing system, and obtain a goods container 300 from each of the shelving units 200 or place the goods container 300 on the shelving unit 200, so as to take, place, and transfer the goods container 300.

The robot 100 provided in the embodiments of this application includes a robot body 110 and a fork apparatus 120. The fork apparatus 120 is arranged on the robot body 110. The fork apparatus 120 may be raised or lowered relative to the robot body 110, and the robot body 110 may move on the ground, so that the fork apparatus 120 may be opposite to different locations of the shelving units 200, to obtain the target goods container 300. After the fork apparatus 120 is docked with the corresponding location of the shelving unit 200, an operation of taking or placing the goods container 300 may be performed.

The fork apparatus 120 includes a telescopic mechanism 121 and a goods retrieval mechanism 122. The telescopic mechanism 121 includes a base plate 1211 and a transmission assembly. The goods retrieval mechanism 122 is connected to the transmission assembly to move along a length direction of the base plate 1211 under the drive of the transmission assembly. The goods retrieval mechanism 122 includes a rotating unit 1222, a connecting base 1223, and a goods retrieval unit 1224. The goods retrieval unit 1224 is arranged on the connecting base 1223. The rotating unit 1222 is configured to drive the connecting base 1223 to rotate relative to the telescopic mechanism 121, so that the goods retrieval mechanism 122 may cause the goods retrieval unit 1224 to have different orientations relative to the fork apparatus 120 through the rotating unit 1222, and the goods retrieval mechanism 122 may take or place the goods container 300 in different directions of the fork apparatus 120 with the telescopic mechanism 121, thereby implementing bidirectional goods retrieval.

In some embodiments, the telescopic mechanism 121 may further include a telescopic plate 1212. The telescopic plate 1212 and the base plate 1211 are arranged to move relative to each other. The transmission assembly 1213 is arranged between the telescopic plate 1212 and the base plate 1211. The goods retrieval mechanism 122 is arranged on the telescopic plate 1212 and connected to the transmission assembly 1213. In operation, the transmission assembly 1213 can not only drive the goods retrieval mechanism 122 to move relative to the telescopic plate 1212, but also drive the telescopic plate 1212 to move relative to the base plate 1211.

It may be understood that the movement of the telescopic plate 1212 relative to the base plate 1211 may cause the fork apparatus 120 to be docked with the location of the shelving unit 200. The movement of the goods retrieval mechanism 122 relative to the telescopic plate 1212 may drag the goods container 300 from the location onto the fork apparatus 120, or push the goods container 300 on the fork apparatus 120 into the location. However, to implement the cooperative work of the goods retrieval mechanism 122 and the telescopic plate 1212, the goods retrieval mechanism 122 is configured to drive the telescopic plate 1212 to stretch bidirectionally relative to the base plate 1211 along the length direction of the base plate 1211 in operation of the transmission assembly 1213.

It should be noted that the telescopic plate 1212 is stretchable from two ends of the base plate 1211 relative to the base plate 1211, that is, may perform an operation of taking or placing goods from or on two sides of the fork apparatus 120. A movement stroke of the telescopic plate 1212 relative to the base plate 1211 depends on a spacing between the fork apparatus 120 and an edge of the shelving unit 200. However, to ensure that during application to different scenarios, the telescopic plate 1212 has an enough movement stroke during bidirectional stretching, a stroke of unidirectional stretching or retraction of the telescopic plate 1212 may be approximately half a length of the telescopic plate 1212, and then a sum of strokes of bidirectional stretching is approximately the length of the telescopic plate 1212.

In addition, the movement stroke of the goods retrieval mechanism 122 relative to the sliding plate 1221 may be approximately the length of the telescopic plate 1212, that is, the goods retrieval mechanism 122 may move between two ends of the telescopic plate 1212. Since the goods retrieval mechanism 122 is connected to the transmission assembly 1213, in operation of the transmission assembly 1213, the goods retrieval mechanism 122 may move relative to the telescopic plate 1212. When the goods retrieval mechanism 122 moves to tail ends of the stroke, that is, moves to the two ends of the telescopic plate 1212, the goods retrieval mechanism 122 may push the telescopic plate 1212 to move relative to the base plate 1211 under the drive of the transmission assembly 1213.

It may be learned from the above that the robot 100 provided in the embodiments of this application drives the goods retrieval mechanism 122 to move relative to the telescopic plate 1212 through the transmission assembly 1213, so that the goods retrieval mechanism 122 may take or place the goods container 300. In addition, the telescopic plate 1212 may be driven through the goods retrieval mechanism 122 to stretch bidirectionally relative to the base plate 1211, so that the fork apparatus 120 may also complete the operation of taking goods in forward and backward directions without rotating, thereby reducing a footprint of the fork apparatus 120, reducing the spacing between the shelving units 200 in the warehousing system, and increasing the warehousing density.

First, a stretching or retraction direction of the telescopic plate 1212 relative to the base plate 1211 is defined as an X direction, and a movement direction of the goods retrieval mechanism 122 relative to the telescopic plate 1212 is also defined as an X direction. A width direction of the fork apparatus 120 is defined as a Y direction, and a direction perpendicular to an XY plane is defined as a Z direction, that is, a height direction of the fork apparatus 120.

A structure of the transmission assembly 1213, the transmission assembly 1213, and a manner of driving the telescopic plate 1212 and the goods retrieval mechanism 122 to move are described in detail below.

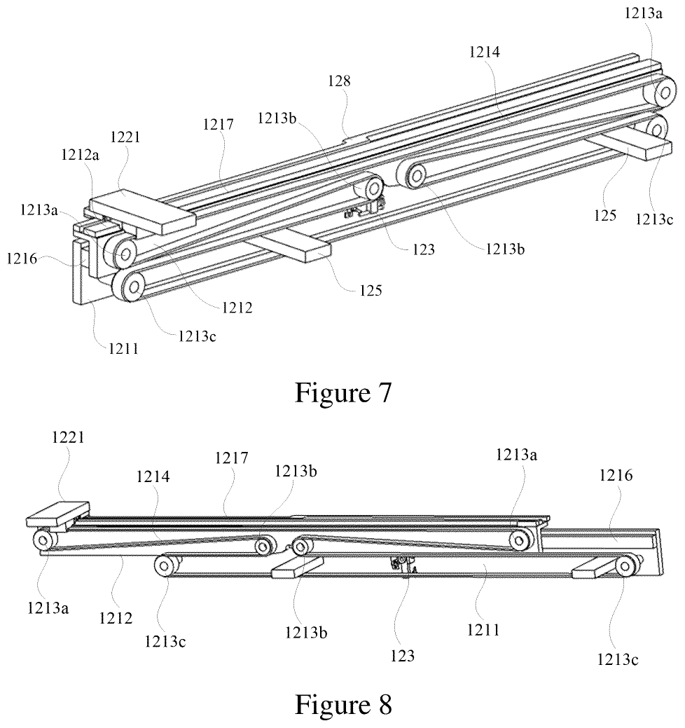

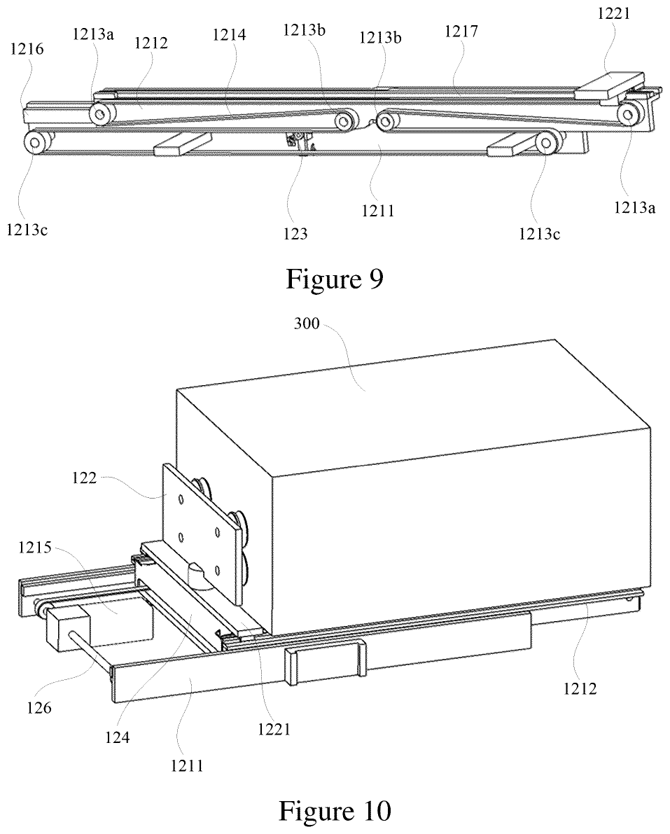

FIG. 6 is a schematic diagram of arrangement of a telescopic mechanism of a fork apparatus in a robot according to an embodiment of this application, FIG. 7 is an axial side view of a telescopic mechanism of a fork apparatus in a robot according to an embodiment of this application, FIG. 8 is a schematic diagram of a telescopic mechanism of a fork apparatus in a robot according to an embodiment of this application stretching toward a front end, and FIG. 9 is a schematic diagram of a telescopic mechanism of a fork apparatus in a robot according to an embodiment of this application stretching toward a rear end.

Referring to FIG. 2 to FIG. 9, in a possible implementation, the transmission assembly 1213 may include a locking mechanism 123, a flexible transmission member 1214, and a transmission wheel set. The transmission wheel set includes a plurality of transmission wheels. The plurality of transmission wheels are respectively located on the base plate 1211 and the telescopic plate 1212. The flexible transmission member 1214 is wrapped around the plurality of transmission wheels, and moves with rotation of the transmission wheel. The locking mechanism 123 is connected between the base plate 1211 and the telescopic plate 1212, to control a relative state of the base plate 1211 and the telescopic plate 1212.

It may be understood that when the locking mechanism 123 is locked, the telescopic plate 1212 and the base plate 1211 are relatively fixed. In this case, relative positions of the transmission wheels on the base plate 1211 and the telescopic plate 1212 remain unchanged, and the flexible transmission member 1214 rolls around the plurality of transmission wheels in sequence in a circumferential direction, and may drive the goods retrieval mechanism 122 to move. However, when the locking mechanism 123 is unlocked, the transmission wheels drive the base plate 1211 and the telescopic plate 1212 to move relative to each other under the drive of the flexible transmission member 1214.

It should be noted that in operation, the transmission assembly 1213 may drive the goods retrieval mechanism 122 or the telescopic plate 1212 into movement based on a locked state of the locking mechanism 123, and driving forces for both movements come from the drive of flexible transmission member, thereby completing the operation of stretching, retracting, or taking or placing goods.

In addition, the transmission assembly 1213 may further include a first driving unit 1215. The first driving unit 1215 is connected to the transmission wheels and configured to drive the transmission wheels to rotate. Bidirectional stretching of the telescopic plate 1212 is realized through forward driving and reverse driving of the first driving unit 1215. For example, in a case that the locking mechanism 123 is unlocked and the goods retrieval mechanism 122 moves to an end portion of the telescopic plate 1212, when an output end of the first driving unit 1215 rotates clockwise, the telescopic plate 1212 stretches from a rear end (a right side in FIG. 9) of the base plate 1211 along the X direction, and when the output end of the first driving unit 1215 rotates counterclockwise, the telescopic plate 1212 is stretchable from a front end (a left side in FIG. 8) of the base plate 1211 along the X direction.

In some embodiments, in order to facilitate assembly of the goods retrieval mechanism 122 and implement a slidable connection between the goods retrieval mechanism 122 and the telescopic plate 1212, the fork apparatus 120 may further include a sliding plate 1221 slidably arranged on the telescopic plate 1212. The goods retrieval mechanism 122 is connected to the sliding plate 1221, and the sliding plate 1221 is connected to the flexible transmission member 1214 and moves with the flexible transmission member 1214.

It may be understood that the goods retrieval mechanism 122 and the sliding plate 1221 are relatively fixed, and the flexible transmission member 1214 and the goods retrieval mechanism 122 are indirectly connected through the sliding plate 1221, to ensure smoothness of movement of the goods retrieval mechanism 122 relative to the telescopic plate 1212. The sliding plate 1221 may move along the X direction under the drive of the flexible transmission member 1214, and a movement stroke of the sliding plate 1221 is the movement stroke of the goods retrieval mechanism 122.

For example, the flexible transmission member 1214 may be a flexible member such as a belt or a chain, and the transmission wheel may be correspondingly a belt wheel, a chain wheel, or the like, which is not specifically limited in the embodiments of this application. A belt and a belt wheel are used as an example. The sliding plate 1221 may be connected to the belt through a toothed plate, the sliding plate 1221 abuts against an outer side of the belt, and the toothed plate is engaged with an inner side of the belt, so that the belt is sandwiched between the toothed plate and the sliding plate 1221. The toothed plate and the sliding plate 1221 may be connected and fixed through fasteners such as screws, and the toothed plate and the sliding plate 1221 may press the belt tightly, so as to ensure reliability of the connection between the sliding plate 1221 and the flexible transmission member 1214.

Since the plurality of transmission wheels are respectively arranged on the base plate 1211 and the telescopic plate 1212, the telescopic plate 1212 may move relative to the base plate 1211 when the locking mechanism 123 is unlocked. Each of the transmission wheels on the telescopic plate 1212 has a variable relative position relative to the transmission wheel on the base plate 1211, so that the flexible transmission member 1214 drives the telescopic plate 1212 to stretch or retract relative to the base plate 1211 during the movement.

It may be understood that through the transmission of the flexible transmission member 1214, in a case that a single driving source is used, that is, only the first driving unit 1215 is used for driving, so that relative movement between the telescopic plate 1212 and the base plate 1211 may be realized, and relative movement between the sliding plate 1221 and the telescopic plate 1212 may also be realized, thereby improving compactness and transmission efficiency of an overall structure of the transmission assembly 1213.

The specific arrangement position and transmission manner of the transmission wheel set are described below.

In a possible implementation, a plurality of transmission wheels include two transmission wheel sets arranged symmetrically. Each of the transmission wheel sets includes a first transmission wheel 1213a, a second transmission wheel 1213b, and a third transmission wheel 1213c. The first transmission wheel 1213a and the second transmission wheel 1213b are arranged on the telescopic plate 1212, and the third transmission wheel 1213c is arranged on the base plate 1211. The flexible transmission member 1214 is wrapped around the first transmission wheel 1213a, the second transmission wheel 1213b, and the third transmission wheel 1213c of one of the transmission wheel sets in sequence, and then wound around the third transmission wheel 1213c, the second transmission wheel 1213b, and the first transmission wheel 1213a of another transmission wheel set, so as to form a closed ring.

The first transmission wheel 1213a and the third transmission wheel 1213c have different positions in a movement direction of the telescopic plate 1212. The flexible transmission belt is wrapped around the first transmission wheel 1213a and the third transmission wheel 1213c in the two transmission wheel sets, and the second transmission wheels 1213b in the two transmission wheel sets are both located outside the closed ring, thereby providing a stroke space for a relative position change between the transmission wheel on the base plate 1211 and the transmission wheel on the telescopic plate 1212.

It may be understood that, the two transmission wheel sets are symmetrically distributed along the movement direction of the telescopic plate 1212, and a spacing between the two second transmission wheels 1213b in the two transmission wheel sets is less than a spacing between two first transmission wheels 1213a, thereby ensuring that the telescopic plate 1212 has an enough stroke of stretching or retracting relative to the base plate 1211, and the strokes of the telescopic plate 1212 stretching bidirectionally relative to the base plate 1211 are symmetrical.

For example, the second transmission wheel 1213b may be located in a middle portion of the telescopic plate 1212 or in a position close to the middle portion, the two first transmission wheels 1213a are respectively located on two ends of the telescopic plate 1212, and two third transmission wheels 1213c may be respectively located on two ends of the base plate 1211. When the telescopic plate 1212 moves relative to the base plate 1211, a formed annular contour of the flexible transmission member 1214 may provide the stroke space for the relative position change of the transmission wheels on the telescopic plate 1212 and the base plate 1211.

It should be noted that the second transmission wheel 1213b and the third transmission wheel 1213c are spaced apart by a spacing in the X direction. When the telescopic plate 1212 stretches from the front end relative to the base plate 1211, a spacing between the second transmission wheel 1213b and the third transmission wheel 1213c in the transmission wheel set at the front end is reduced, and a spacing between the second transmission wheel 1213b and the third transmission wheel 1213c in the transmission wheel set at the rear end is increased. However, when the telescopic plate 1212 stretches from the rear end relative to the base plate 1211, a spacing between the second transmission wheel 1213b and the third transmission wheel 1213c in the transmission wheel set at the front end is increased, and a spacing between the second transmission wheel 1213b and the third transmission wheel 1213c in the transmission wheel set at the rear end is reduced. In addition, a sum of the two spacings between the second transmission wheels 1213b and the third transmission wheels 1213c in the two transmission wheel sets remains unchanged.

Furthermore, one of the plurality of transmission wheels may be a driving wheel, and another transmission wheel may be a driven wheel. For example, the third transmission wheel 1213c in any of the two transmission wheel sets may serve as a driving wheel. The first driving unit 1215 is connected to the driving wheel to drive the driving wheel to rotate, and the driving wheel drives the flexible transmission member 1214 to drive the driven wheel to rotate.

In some embodiments, the telescopic plate 1212 and the base plate 1211 may extend in a same direction, that is, both extend along the X direction. The two ends of the telescopic plate 1212 are respectively provided with an abutting portion 1212a. When the sliding plate 1221 abuts against the abutting portion 1212a, the flexible transmission member 1214 pushes the telescopic plate 1212 to move through the sliding plate 1221, so as to provide a limit for the movement of the sliding plate 1221 relative to the telescopic plate 1212, and the sliding plate 1221 may drive the telescopic plate 1212 to move by abutting against the abutting portion 1212a.

It may be understood that in operation of the flexible transmission member 1214 in a first direction (counterclockwise), the telescopic plate 1212 stretches from a first end (a front end) of the base plate 1211, or the telescopic plate 1212 retracts from a second end (a rear end) of the base plate 1211. In operation of the flexible transmission member 1214 in a second direction (clockwise), the telescopic plate 1212 stretches from the second end of the base plate 1211, or the telescopic plate 1212 retracts from the first end of the base plate 1211.

It should be noted that the telescopic mechanism 121 may further include a first sliding rail 1216 and a second sliding rail 1217. The first sliding rail 1216 may be arranged between the base plate 1211 and the telescopic plate 1212, and the first sliding rail 1216 extends along a length direction of the base plate 1211. The second sliding rail 1217 is arranged on the telescopic plate 1212, the second sliding rail 1217 extends along a length direction of the telescopic plate 1212, and the sliding plate 1221 is configured to move along the second sliding rail 1217.

It may be understood that the first sliding rail 1216 and the second sliding rail 1217 both extend along the X direction. The base plate 1211 may support the telescopic plate 1212 through the first sliding rail 1216, and the telescopic plate 1212 may support the sliding plate 1221 through the second sliding rail 1217, thereby ensuring smoothness of movement of the telescopic plate 1212 and the sliding plate 1221.

FIG. 10 is a schematic diagram of a fork apparatus bearing a goods container in a robot according to an embodiment of this application. Referring to FIG. 3 to FIG. 10, in a possible implementation, two telescopic mechanisms 121 may be arranged. The fork apparatus 120 may further include a tray 124, a connecting bracket 125, and a transmission shaft 126. The two telescopic mechanisms 121 are symmetrically distributed on two sides of the tray 124. Telescopic plates 1212 of the two telescopic mechanisms 121 are respectively connected to the two sides of the tray 124, and base plates 1211 of the two telescopic mechanisms 121 are connected through the connecting bracket 125. The tray 124 is configured to bear the goods container 300.

It may be understood that the two base plates 1211 and the two telescopic arms are arranged in parallel. The sliding plate 1221 may extend along a Y direction, and two ends of the sliding plate 1221 are respectively slidably connected to the telescopic plates 1212 of the two telescopic mechanisms 121. The first driving unit 1215 may be arranged between the two telescopic mechanisms 121, and an output end of the first driving unit 1215 is connected to the transmission shaft 126. The transmission shaft 126 may extend along the Y direction, and two ends of the transmission shaft 126 may be respectively connected to transmission wheels of the two telescopic mechanisms 121, thereby ensuring a reasonable layout of an overall structure of the fork apparatus 120 and increasing a space utilization rate. The symmetrically distributed telescopic mechanisms 121 cause movement of the tray 124 to be stable and reliable.

For example, the first driving unit 1215 may be a motor, and the motor may be mounted on the connecting bracket 125 between the two base plates 1211. An output shaft of the motor may be connected to the transmission shaft 126 through a transmission component of a gear or a speed reducer, so that the motor drives the transmission shaft 126 to rotate during operation. The motor may be arranged on a lateral side of the transmission shaft 126 to increase the space utilization rate. A model and output power of the first driving unit 1215 and a transmission ratio of the first driving unit to the transmission shaft 126 are not specifically limited in the embodiments of this application.

In some embodiments, two ends of the tray 124 along a stretching or retracting direction of the telescopic plate 1212 may be each provided with a buffer pad 1241. In other words, a front end and a rear end of the telescopic plate 1212 along the stretching or retracting direction thereof may be each provided with the buffer pad 1241. When the telescopic plate 1212 is docked with an external shelving unit 200, the buffer pad may act as a buffer to avoid rigid impact.

It may be understood that one or more buffer pads 1241 may be arranged, and the buffer pad 1241 may protrude from an end portion of the telescopic plate 1212. When the telescopic plate 1212 stretches relative to the base plate 1211 and is docked with an edge of a location of the shelving unit 200, the buffer pad 1241 abuts against the edge of the location of the shelving unit 200. The buffer pad 1241 may be elastic, so as to mitigate an impact force and prevent the impact force from being transmitted to the telescopic plate 1212.

For example, two buffer pads 1241 may be arranged on each end of the telescopic plate 1212 and arranged at intervals along the Y direction. The buffer pads 1241 may be made of a material including but not limited to rubber, silica gel, sponge, or the like, which is not specifically limited in the embodiments of this application.

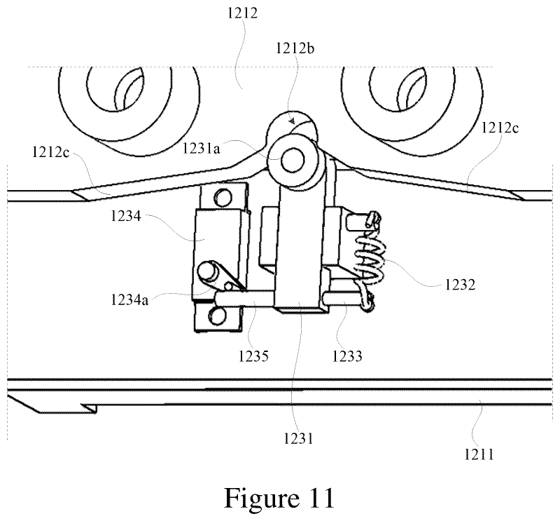

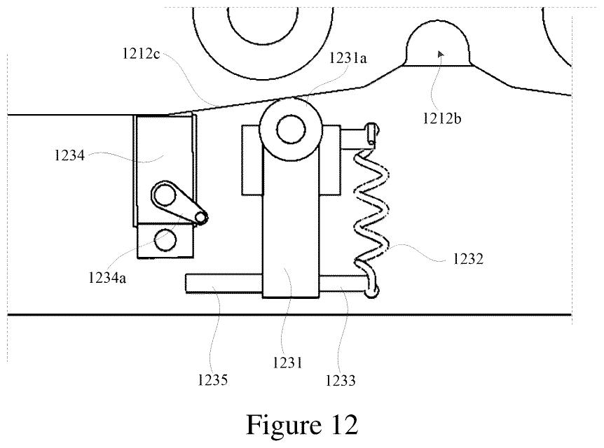

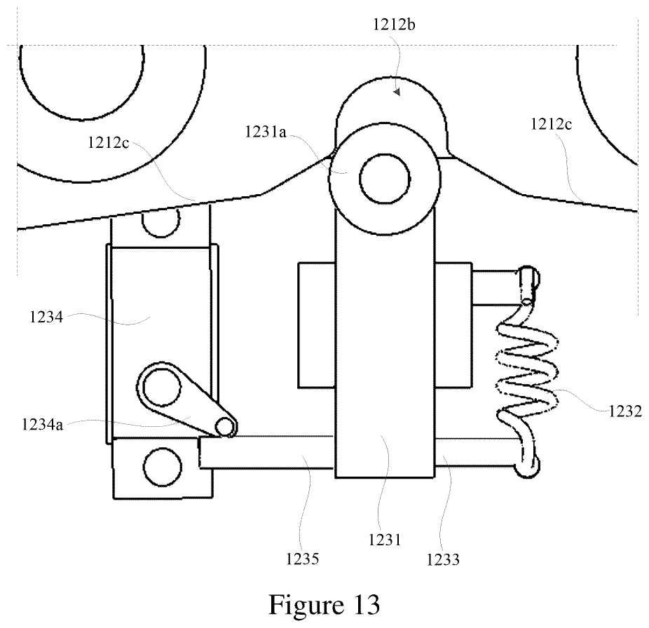

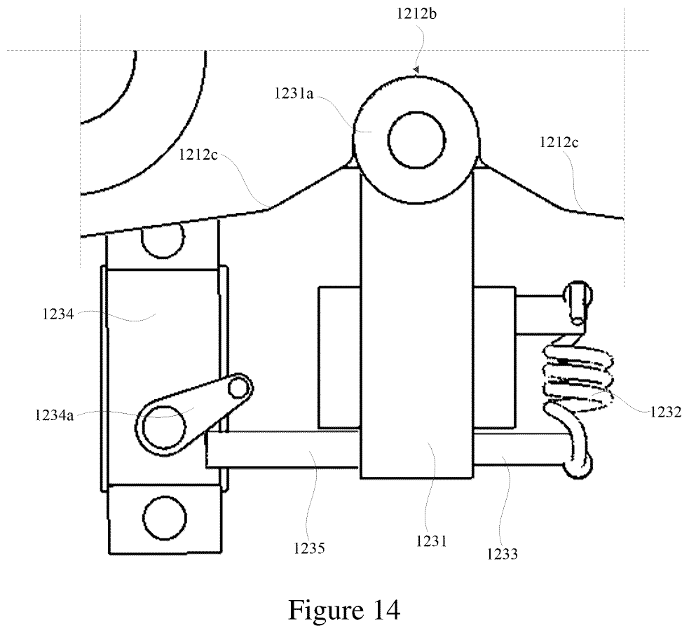

FIG. 11 is a schematic diagram of a locking mechanism of a fork apparatus in a robot according to an embodiment of this application, FIG. 12 is a schematic diagram of unlocking a locking mechanism of a fork apparatus in a robot according to an embodiment of this application, FIG. 13 is a schematic diagram of a rocker arm of a locking mechanism of a fork apparatus in a robot according to an embodiment of this application in a first position, and FIG. 14 is a schematic diagram of a rocker arm of a locking mechanism of a fork apparatus in a robot according to an embodiment of this application in a second position.

A specific structure and locking manner of the locking mechanism 123 are described in detail below.

Referring to FIG. 3 to FIG. 14, in a possible implementation, the locking mechanism 123 may be arranged on the base plate 1211, the locking mechanism 123 may include a locking member 1231, and the telescopic plate 1212 may be provided with a positioning groove 1212b. The locking member 1231 may be inserted into the positioning groove 1212b or detached from the positioning groove 1212b, so as to lock or unlock the telescopic plate 1212 and the base plate 1211, thereby ensuring reliability of the locking and unlocking process of the telescopic plate 1212 relative to the base plate 1211, and avoiding loose locking or jamming.

The locking member 1231 may move along a vertical direction relative to the positioning groove 1212b, that is, the locking member 1231 may move along the Z direction. When the locking member 1231 is inserted into the positioning groove 1212b, the telescopic plate 1212 is locked with the base plate 1211. In this case, in operation of the flexible transmission member 1214, the sliding plate 1221 may be driven to move relative to the telescopic plate 1212, thereby dragging the goods container 300 onto the fork apparatus 120, or pushing the goods container 300 away from the fork apparatus 120. When the locking member 1231 is detached from the positioning groove 1212b, the telescopic plate 1212 is unlocked from the base plate 1211. In this case, the operation of the flexible transmission member 1214 may drive the telescopic plate 1212 to stretch or retract.

It may be understood that the locking mechanism 123 may be located in the middle position of the fork apparatus 120, that is, the locking member 1231 may be mounted in a middle portion of the base plate 1211, and the middle portion of the telescopic plate 1212 is provided with a positioning groove 1212b. When the locking member 1231 may be inserted into the positioning groove 1212b for locking, the middle portion of the telescopic plate 1212 is opposite to the middle portion of the base plate 1211, that is, the telescopic plate 1212 is in a retracted state. In this way, when the goods retrieval mechanism 122 pulls the goods container 300 onto the fork apparatus 120, the telescopic plate 1212 is prevented from stretching in a reverse direction beyond a neutral position when retracting under the friction of the goods container 300, so that the telescopic plate 1212 may be maintained in the neutral position relative to the base plate 1211 after each operation of taking or placing goods.

In some embodiments, the locking mechanism 123 may further include a first elastic member 1232, the locking member 1231 is slidably arranged on the base plate 1211, and the locking member 1231 is provided with a hanging pin 1233. A first end of the first elastic member 1232 is connected to the hanging pin 1233, a second end of the first elastic member 1232 is connected to the base plate 1211, and the first elastic member 1232 applies an elastic force toward the positioning groove 1212b to the locking member 1231.

It may be understood that the base plate 1211 may be provided with a guide hole, the locking member 1231 may be inserted into the guide hole, and the first elastic member 1232 may provide an elastic force along the Z direction for the locking member 1231, thereby maintaining the reliability of the locked state of the locking member 1231 through the elastic force provided by the first elastic member 1232.

For example, the first elastic member 1232 may be a tension spring, the hanging pin 1233 may be a protruding structure on a lateral side of the locking member 1231, the hanging pin 1233 and the locking member 1231 may be integrally formed, or the hanging pin 1233 may be welded to or inserted into the locking member 1231. A magnitude of the elastic force of the first elastic member 1232 and the specific connection manner of the hanging pin 1233 are not specifically limited in the embodiments of this application.

In order to implement active locking and unlocking of the locking mechanism and improve efficiency of movement of the locking member 1231, the locking mechanism 123 may further include a second driving unit 1234. An output end of the second driving unit 1234 is provided with a rocker arm 1234a. The second driving unit 1234 may drive the rocker arm 1234a to rotate, and the locking member 1231 is provided with a stop pin 1235. When the rocker arm 1234a is in the first position, the rocker arm 1234a abuts against the stop pin 1235 to disengage the locking member 1231 from the positioning groove 1212b. When the rocker arm 1234a is in the second position, the rocker arm 1234a is detached from the stop pin 1235, and the locking member 1231 is engaged with the positioning groove 1212b under the elastic force of the first elastic member 1232.

For example, the second driving unit 1234 may be a steering engine. An end portion of the rocker arm 1234a is connected to a rotating shaft of the steering engine. A swing of the rocker arm 1234a between the first position and the second position is realized through forward and reverse rotation of the rotating shaft of the second driving unit 1234, and an amplitude of the swing of the rocker arm 1234a between the first position and the second position may be determined by a movement stroke of the locking member 1231 relative to the positioning groove 1212b, which is not specifically limited in the embodiments of this application.

It should be noted that the second driving unit 1234 may be arranged on the lateral side of the locking member 1231, and the second driving unit 1234 and the first elastic member 1232 may be respectively located on two opposite sides of the locking member 1231. Correspondingly, the stop pin 1235 and the hanging pin 1233 may be respectively located on two opposite sides of the locking member 1231, and a structure of the stop pin 1235 and a connection manner of the stop pin and the locking member 1231 are similar to those of the hanging pin 1233. Details are not described herein again.

In addition, an end of the locking member 1231 facing the positioning groove 1212b is provided with a roller 1231a, two opposite sides of the positioning groove 1212b along the movement direction of the telescopic plate 1212 are each provided with a guide surface 1212c, and the guide surfaces 1212c on two sides of the positioning groove 1212b are both inclined toward the positioning groove 1212b, to guide the roller 1231a to roll, thereby providing guidance for the roller 1231a when the roller 1231a slides out of the positioning groove 1212b.

It may be understood that the second driving unit 1234 is mainly configured to unlock the locking member 1231 from the positioning groove 1212b, so that the telescopic plate 1212 may move relative to the base plate 1211. After the telescopic plate 1212 moves relative to the base plate 1211, the locking member 1231 may abut against the telescopic plate 1212 through the roller 1231a at the end portion, and roll along the telescopic plate 1212 with the movement of the telescopic plate 1212.

It should be noted that when the telescopic plate 1212 needs to return to the neutral position, and the roller 1231a contacts the guide surface 1212c, since the guide surface 1212c is inclined relative to a horizontal direction, that is, inclined relative to the X direction, the first elastic member 1232 applies an elastic force to the locking member 1231, and a component force of an abutment force of the roller 1231a of the locking member 1231 on the guide surface 1212c in the horizontal direction may force the telescopic plate 1212 to return to the neutral position, that is, cause the roller 1231a to roll into the positioning groove 1212b relative to the telescopic plate 1212.

For example, two guide surfaces 1212c may be symmetrically distributed on the two sides of the positioning groove 1212b, and each of the guide surfaces 1212c may have a different inclination angle in a different position along an extension direction thereof. The inclination angle of an end of the guide surface 1212c close to the positioning groove 1212b relative to the horizontal direction may be greater than an inclination angle of an end of the guide surface facing away from the positioning groove 1212b relative to the horizontal direction, and the inclination angle of the guide surface 1212c relative to the horizontal direction may range from 0° to 90°. For example, the inclination angle may be 10°, 20°, 30°, 45°, 60°, 80°, or the like. In addition, the guide surface 1212c may be a plane or an arc surface, which is not specifically limited in the embodiments of this application. When the guide surface 1212c is an arc surface, the inclination angle of the guide surface 1212c is an included angle between a tangent of the guide surface and the horizontal direction.

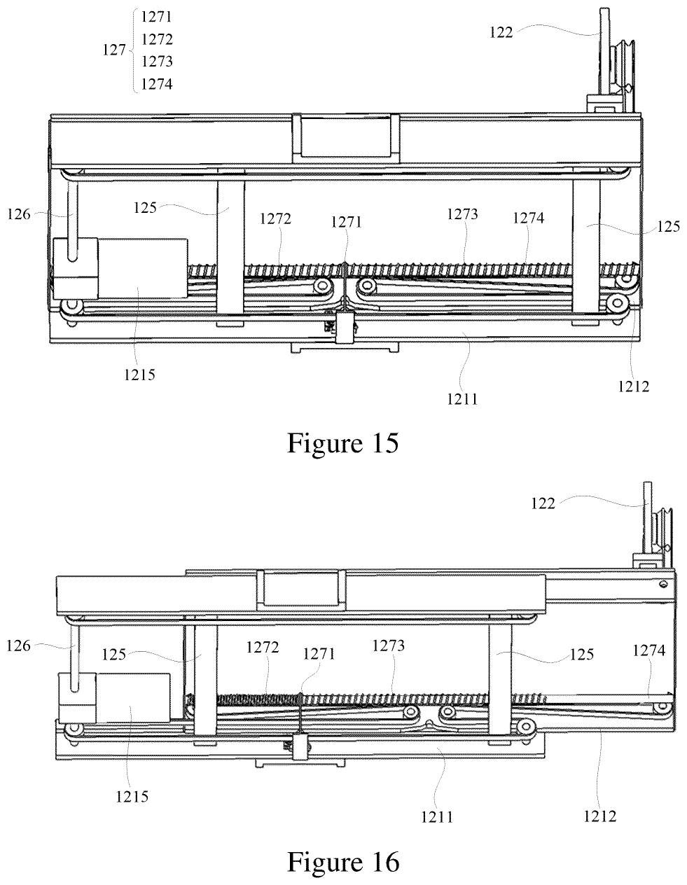

FIG. 15 is a schematic structural diagram of a reset mechanism of a fork apparatus in a robot according to an embodiment of this application, and FIG. 16 is a schematic diagram of a reset mechanism of a fork apparatus in a robot according to an embodiment of this application in a stretched state.

During retrieval or storage of the goods container 300 by the fork apparatus 120, when the telescopic plate 1212 is retracted from the stretched state, the telescopic plate may be retracted to a neutral state through the transmission assembly 1213, and the retraction of the telescopic plate 1212 may further be assisted by setting a reset mechanism 127. A structure of the reset mechanism 127 is described below.

Referring to FIG. 15 and FIG. 16, and with reference to FIG. 2 to FIG. 5, in a possible implementation, the fork apparatus 120 may further include a reset mechanism 127. The reset mechanism 127 may include a reset baffle 1271, a second elastic member 1272, and a third elastic member 1273. The reset baffle 1271 is connected to the base plate 1211. The second elastic member 1272 and the third elastic member 1273 are both arranged on the telescopic plate 1212. The second elastic member 1272 and the third elastic member 1273 both abut against the reset baffle 1271, and when the telescopic plate 1212 stretches relative to the base plate 1211, one of the second elastic member 1272 and the third elastic member 1273 applies an elastic force toward the retraction direction of the telescopic plate 1212 to the telescopic plate 1212.

It may be understood that after the telescopic plate 1212 stretches relative to the base plate 1211 and needs to retract, the reset mechanism 127 provides the elastic force to realize quick reset. Since the telescopic plate 1212 is stretchable bidirectionally relative to the base plate 1211, the second elastic member 1272 and the third elastic member 1273 may respectively provide the elastic force for resetting required during stretching in forward and backward directions.

In some embodiments, the reset mechanism 127 may further include a guide shaft 1274. The guide shaft 1274 is arranged on the telescopic plate 1212, and the guide shaft 1274 extends along the stretching or retraction direction of the telescopic plate 1212. The second elastic member 1272 and the third elastic member 1273 are both sleeved on the guide shaft 1274 and arranged along an extension direction of the guide shaft 1274. The reset baffle 1271 is located between the second elastic member 1272 and the third elastic member 1273.

It may be understood that two ends of the guide shaft 1274 may be respectively connected to two ends of the telescopic plate 1212. The guide shaft 1274 extends along the X direction, and may provide guidance for compression and rebound of the second elastic member 1272 and the third elastic member 1273, thereby ensuring that a direction of the provided elastic force is consistent with the retraction direction of the telescopic plate 1212.

For example, the second elastic member 1272 and the third elastic member 1273 may be both a spring. The reset baffle 1271 may be provided with a through hole, so that when the guide shaft 1274 is mounted, the guide shaft 1274 may pass through the through hole on the reset baffle 1271. The second elastic member 1272 and the third elastic member 1273 may have a same damping coefficient. The specific damping coefficient of the second elastic member 1272 and the third elastic member 1273 is not specifically limited in the embodiments of this application.

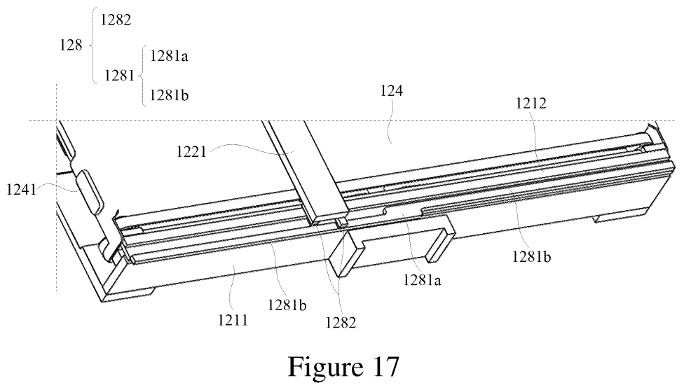

FIG. 17 is a schematic diagram of a detection assembly of a fork apparatus in a robot according to an embodiment of this application.

Since the telescopic plate 1212 is stretchable bidirectionally relative to the base plate 1211, that is, stretchable or retractable forward and backward along the X direction, relative to a stretched state on two sides, a neutral position of the telescopic plate 1212 relative to the base plate 1211 is in a retracted state. In order to accurately determine whether the stretching direction and the stretched state of the telescopic plate 1212 relative to the base plate 1211 may be realized through a detection assembly 128, a detection manner of the detection assembly 128 is described in detail below.

Referring to FIG. 17, and with reference to FIG. 2 to FIG. 5, in a possible implementation, the fork apparatus 120 may further include a detection assembly 128. The detection assembly 128 may include a controller (not shown), a sensing plate 1281, and two first detection units 1282. The first detection units 1282 are both arranged on the sliding plate 1221, and each of the first detection units 1282 is electrically connected to the controller. The sensing plate 1281 is arranged on the telescopic plate 1212, and the sensing plate 1281 extends along the length direction of the telescopic plate 1212. The first detection unit 1282 feeds back a detection signal when being opposite to the sensing plate 1281, and the controller is configured to determine a position of the sliding plate 1221 relative to the telescopic plate 1212 based on the detection signal.

It may be understood that the sensing plate 1281 may extend along the X direction. When the telescopic plate 1212 moves relative to the base plate 1211, the first detection unit 1282 moves relative to the sensing plate 1281. When the first detection unit 1282 is opposite to the sensing plate 1281 in different positions, different detection signals may be fed back, so that the stretching or retraction state of the telescopic plate 1212 relative to the base plate 1211 in different directions may be accurately determined.

In some embodiments, the sensing plate 1281 may include a first sensing section 1281a and two second sensing sections 1281b respectively connected to two opposite ends of the first sensing section 1281a. The first sensing section 1281a passes through a midpoint of the sensing plate 1281 in the length direction, and the two second sensing sections 1281b are arranged in a staggered manner relative to a width direction of the telescopic plate 1212. The two first detection units 1282 are arranged in a staggered manner in the width direction of the telescopic plate 1212. When the sliding plate 1221 moves, one of the two first detection units 1282 is opposite to the second sensing section 1281b, or the two first detection units 1282 are both opposite to the first sensing section 1281a, thereby determining whether the telescopic plate 1212 is in the neutral position.

For example, the first sensing section 1281a is located in a middle portion of the base plate 1211, the two second sensing sections 1281b both extend along the X direction, and the two second sensing sections 1281b are arranged in a staggered manner in the Y direction. The first detection unit 1282 may be arranged in the middle position of the telescopic plate 1212, and the two first detection units 1282 may be distributed in a staggered manner relative to the Y direction. When the telescopic plate 1212 stretches, only one of the two first detection units 1282 is opposite to the second sensing section 1281b. The stretching direction of the telescopic plate 1212 may be determined based on different signals fed back by the two first detection units 1282. When the telescopic plate 1212 retracts, the two first detection units 1282 are simultaneously opposite to the first sensing section 1281a, and feed back a same signal, so that it may be determined whether the telescopic plate 1212 has returned to the neutral position.

It should be noted that the locking mechanism 123, the reset mechanism 127, and the detection assembly 128 are all located on a lateral side of the fork apparatus 120. The detection assembly 128 may be arranged on a single side of the fork apparatus 120, or the locking mechanism 123, the reset mechanism 127, and the detection assembly 128 are all arranged on both sides of the fork apparatus 120, which is not specifically limited in the embodiments of this application.

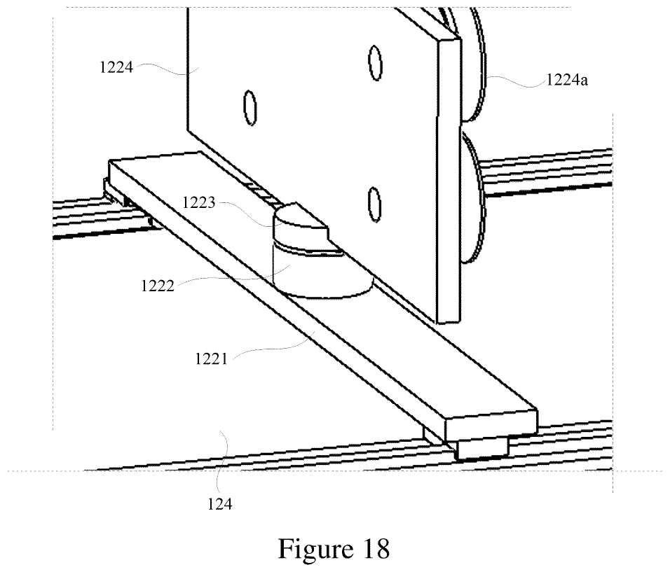

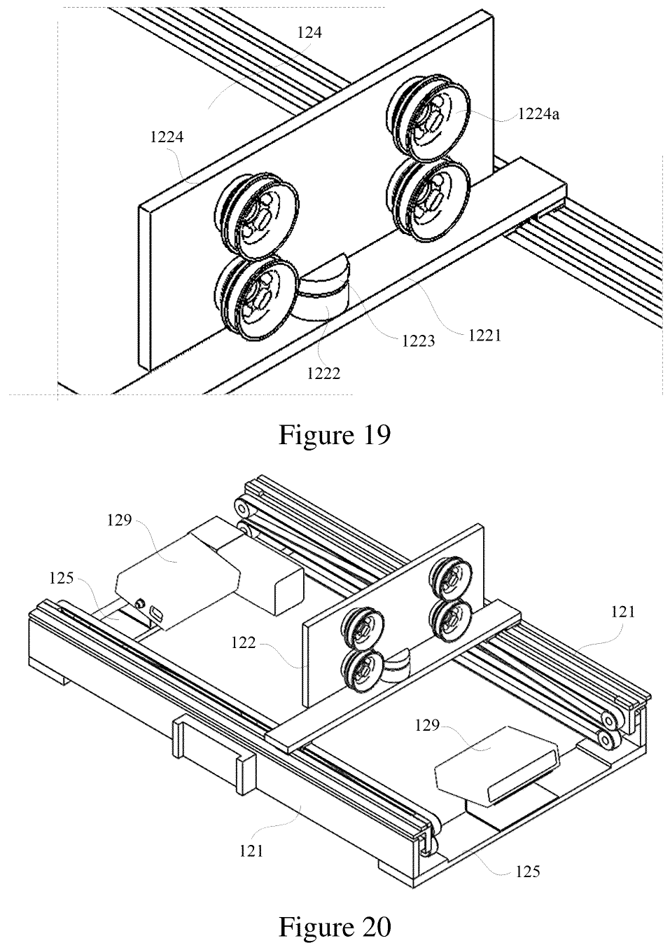

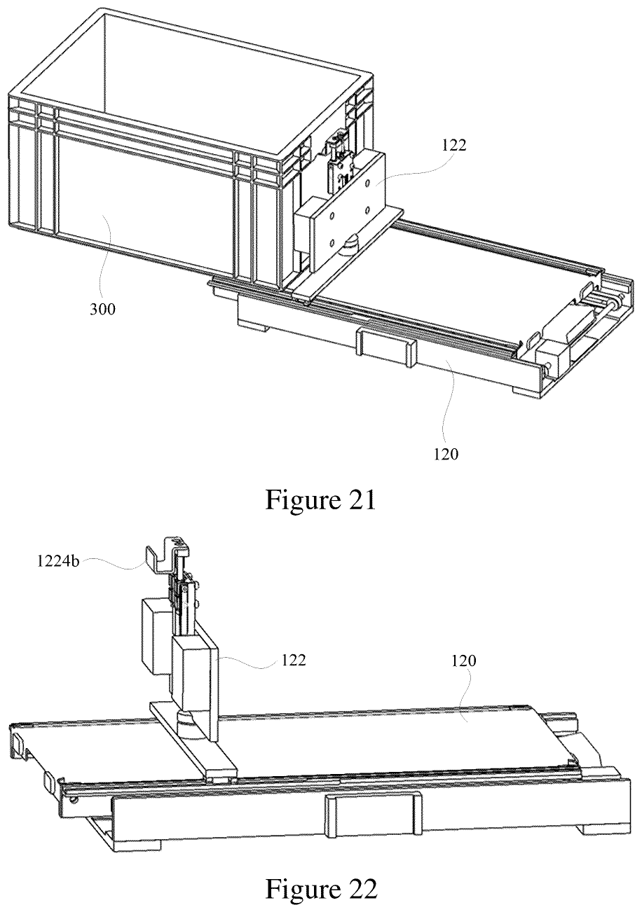

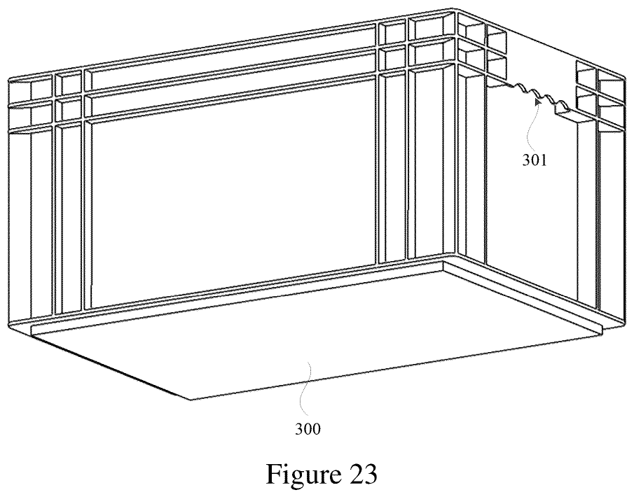

FIG. 18 is a schematic diagram of a first goods retrieval mechanism of a fork apparatus in a robot according to an embodiment of this application, FIG. 19 is a schematic diagram of a first goods retrieval mechanism of a fork apparatus in a robot according to an embodiment of this application from another perspective, FIG. 20 is a schematic diagram of arrangement of a second detection unit of a fork apparatus in a robot according to an embodiment of this application, FIG. 21 is a schematic diagram of a second goods retrieval mechanism of a fork apparatus in a robot according to an embodiment of this application, FIG. 22 is a schematic diagram of a second goods retrieval mechanism of a fork apparatus in a robot according to an embodiment of this application from another perspective, and FIG. 23 is a schematic diagram of a robot transferring a goods container according to an embodiment of this application.

A specific structure and goods retrieval manner of the goods retrieval mechanism 122 are described below.

Referring to FIG. 18 to FIG. 21, and with reference to FIG. 2 to FIG. 5, in a possible implementation, the goods retrieval mechanism 122 may include a rotating unit 1222, a connecting base 1223, and a goods retrieval unit 1224. The rotating unit 1222 is arranged on the sliding plate 1221. The goods retrieval unit 1224 may be connected to the rotating unit 1222 through the connecting base 1223. The rotating unit 1222 is configured to drive the connecting base 1223 to rotate and drive the goods retrieval unit 1224 to rotate, so that the goods retrieval unit 1224 faces the stretching direction of the telescopic plate 1212.

It may be understood that since the telescopic plate 1212 stretches or retracts relative to the base plate 1211 along the X direction, correspondingly, the goods retrieval mechanism 122 needs to face different sides of the fork apparatus 120 to take or place goods. Through arrangement of the rotating unit 1222, the goods retrieval mechanism 122 may rotate by 180° as a whole, thereby reversing the orientation of the goods retrieval unit 1224 on the goods retrieval mechanism 122, so that when the telescopic plate 1212 stretches or retracts in different directions, the goods retrieval mechanism 122 may take or place the goods containers 300 on different sides through rotating the direction.

The goods retrieval mechanism 122 may cooperate with the goods container 300 in different manners, which is described through examples below.

Referring to FIG. 18 to FIG. 20, in a first optional implementation, the goods retrieval unit 1224 may include a mounting plate and a plurality of suction cups 1224a. The mounting plate is connected to the connecting base 1223, the mounting plate is vertically arranged, and the plurality of suction cups 1224a are arranged in an array on the mounting plate. After the telescopic plate 1212 is docked with the shelving unit 200, the goods retrieval mechanism 122 moves to an end portion of the telescopic plate 1212, and may abut against an end surface of the goods container 300 facing outside of a location of the shelving unit 200, and the suction cups 1224a may absorb the end surface of the goods container 300, thereby preventing the telescopic plate 1212 from entering an interior of the location of a warehouse, reducing a container spacing during storage of the goods container 300, and further increasing the storage density.

For example, four suction cups 1224a may be arranged. The four suction cups 1224a are arranged in a square array on the mounting plate. Each of the suction cups 1224a may be a pneumatic suction cup 1224a that uses negative pressure for adsorption, or may be an electromagnetic suction cup 1224a that generates a suction force after the suction cup 1224a is powered, which may be set based on the end surface material of the goods container 300 and is not specifically limited in the embodiments of this application.

Referring to FIG. 21 to FIG. 23, in a second optional implementation, the goods retrieval unit 1224 may include a mounting plate and an insert plate 1224b. The insert plate 1224b is arranged on the mounting plate, and the insert plate 1224b may move relative to the mounting plate. The insert plate 1224b is configured to be insertable into a handle groove 301 of the goods container 300, and the handle of the goods container 300 is located at an end of the goods container 300 facing the outside of the location of the shelving unit 200, thereby preventing the telescopic plate 1212 from entering the interior of the location of the warehouse, reducing the container spacing during storage of the goods container 300, and further increasing the storage density.

For example, the insert plate 1224b may be slidably connected to the mounting plate, and the mounting plate may be provided with a motor. The motor drives the insert plate 1224b to move along a vertical direction relative to the mounting plate, that is, move along a Z direction, so that when the goods retrieval mechanism 122 cooperates with the goods container 300, the insert plate 1224b is inserted into the handle groove 301 of the goods container 300. However, after the operation of taking or placing goods is completed, the insert plate 1224b is detached from the handle groove 301 of the goods container 300 under the drive of the motor.

It should be noted that the robot 100 may further include at least two second detection units 129. The at least two second detection units 129 are respectively arranged on two ends of the fork apparatus 120, to detect the goods container 300 in a different goods retrieval or storage direction of the fork apparatus 120, so that during retrieval or storage of the goods container 300, the location and information about the goods container 300 may be accurately identified.

For example, the second detection unit 129 may be a visual sensor such as a camera, may be a scanner, or the like, to identify identifiers of the goods container 300 and the location of the shelving unit 200. Two third sensors may be arranged. The two third sensors may be mounted on the connecting bracket 125 between the base plates 1211, and the two third sensors may be respectively located on the two ends of the fork apparatus 120.

In addition, it should be noted that in order to cause the fork apparatus 120 to perform the operation of taking or placing goods in positions at different heights, the robot 100 may further include a lifting mechanism 130. A robot body 110 may include a chassis 111 and a stand 112. The stand 112 may be arranged on the chassis 111, the fork apparatus 120 is connected to the lifting mechanism 130, and the lifting mechanism 130 is configured to move along a height direction of the stand 112.

The lifting mechanism 130 may be connected to the stand 112 through a sliding groove, the lifting mechanism 130 may be located on two opposite sides of the fork apparatus 120, and the lifting mechanism 130 may move up and down along the Z direction relative to the stand 112 through chain drive or belt drive. The specific driving manner of the lifting mechanism 130 is not limited in the embodiments of this application.

Referring to FIG. 1 and FIG. 2, the embodiments of this application further provide a warehousing system. The warehousing system includes a shelving unit 200 and the robot 100 in the foregoing technical solutions. A plurality of shelving units 200 may be arranged. The plurality of shelving units 200 are arranged at intervals. An aisle 201 is arranged between adjacent shelving units 200. A width of the aisle 201 matches a width of the robot 100. The robot 100 moves in the aisle 201, and the fork apparatus 120 of the robot 100 is stretchable bidirectionally along a width direction of the aisle 201, to take or place a goods container 300 on each of the shelving units 200 on two sides of the aisle 201.

It may be understood that since the fork apparatus 120 of the robot 100 may take goods on two sides along the width direction of the aisle 201, the fork apparatus 120 does not need to reverse the orientation, and the aisle 201 does not need to reserve space for the fork apparatus 120 to rotate, thereby increasing the warehousing density of the warehousing system.

In some embodiments, the shelving unit 200 may have a plurality of warehousing layers 210. The plurality of warehousing layers 210 are arranged along a height direction of the shelving unit 200. The plurality of warehousing layers 210 include at least one transfer layer. The transfer layer is located at a bottom of the shelving unit 200. The robot 100 is configured to take or place the goods container 300 between the transfer layer and a different warehousing layer 210. The warehousing system may further include a transfer device (not shown). The transfer device is configured to take or place the goods container 300 from or on the transfer layer. In this way, cooperation between a large-size vehicle and a small-size vehicle may be implemented, thereby improving logistics efficiency of the warehousing system.

It should be noted that when the warehousing system performs a storage process, the transfer device may first transfer a to-be-stored goods container 300 to the transfer layer of the shelving unit 200, that is, first store the to-be-stored goods container on a bottom layer of the shelving unit 200, and then the robot 100 places the goods container 300 on the transfer layer in a target location of the corresponding warehousing layer 210. However, when the warehousing system performs a retrieval process, the robot 100 may place a to-be-retrieved goods container 300 from the warehousing layer 210 to the transfer layer, and then the transfer device obtains and transfer the to-be-retrieved goods container to a position such as an external conveyor or a sorting table.

A process of taking the goods container 300 from the shelving unit 200 by the robot 100 is described below.

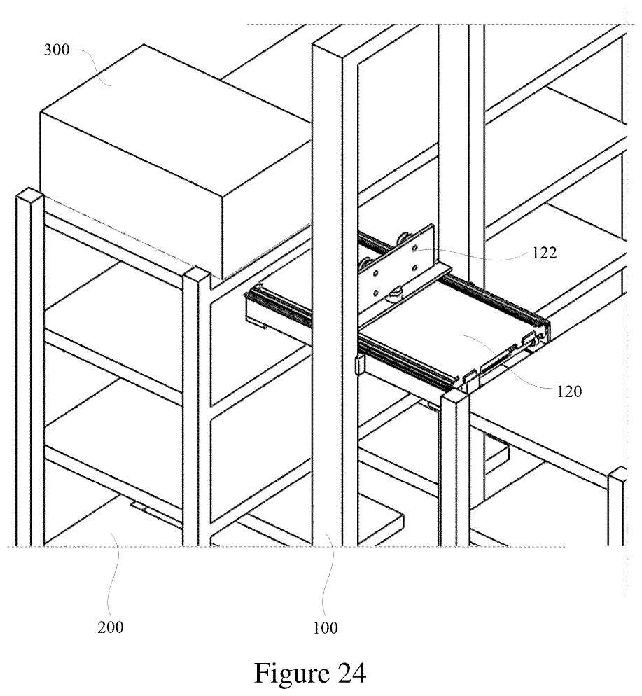

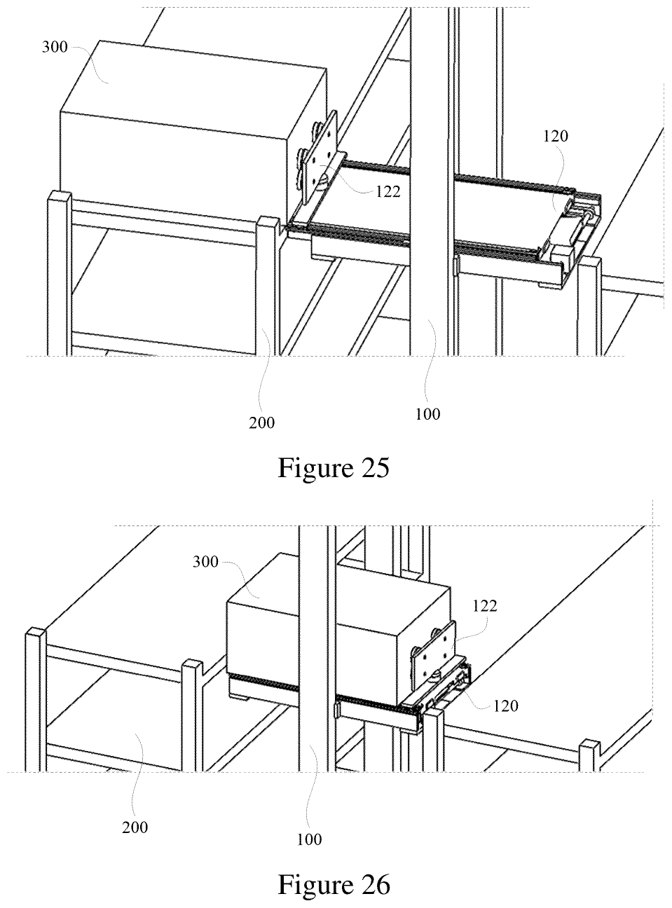

FIG. 24 is a schematic diagram of a first state of a robot according to an embodiment of this application during goods retrieval, FIG. 25 is a schematic diagram of a second state of a robot according to an embodiment of this application during goods retrieval, and FIG. 26 is a schematic diagram of a third state of a robot according to an embodiment of this application during goods retrieval.

Referring to FIG. 24 to FIG. 26, a process of obtaining a goods container 300 is as follows.
\textcircled{1}: A robot 100 moves in an aisle to a position where a target location is located, and a fork apparatus 120 moves to a height position corresponding to the target location.
\textcircled{2}: A goods retrieval mechanism 122 of the fork apparatus 120 moves towards the goods container 300, and drives a telescopic plate 1212 to stretch forward and abut against an edge of a shelving unit 200, and the goods retrieval mechanism 122 is docked with an end surface of the goods container 300.
\textcircled{3}: The goods retrieval mechanism 122 moves back and drives the goods container 300 to move onto the fork apparatus 120, and the telescopic plate 1212 returns to an neutral position relative to the base plate 1211, to complete the goods retrieval process.

A process of storing the goods container 300 on the shelving unit 200 is an inverse process of the foregoing process of obtaining the goods container 300. Details are not described herein again.

For the application scenarios of the warehousing system provided in the embodiments, based on the types of specific goods, the robot may be applied to different fields such as retrieval or storage of manufacturing factory production lines or inventory products, retail logistics, and retrieval or storage of parcels of e-commerce logistics, and products or goods to be transported may be industrial parts, electronic accessories or products, clothing accessories, food, and the like, which is not specifically limited in the embodiments of this application.

Finally, it should be noted that the foregoing embodiments are merely used for describing the technical solutions of this application, but are not intended to limit this application. Although this application is described in detail with reference to the foregoing embodiments, it should be appreciated by a person skilled in the art that, modifications may still be made to the technical solutions described in the foregoing embodiments, or equivalent replacements may be made to some or all of the technical features. However, these modifications or replacements do not cause the essence of corresponding technical solutions to depart from the scope of the technical solutions in the embodiments of this application.

1. A robot, configured to take or place a goods container, wherein the robot comprises a robot body and a fork apparatus, and the fork apparatus is arranged on the robot body; and the fork apparatus comprises a telescopic mechanism and a goods retrieval mechanism, the telescopic mechanism comprises a base plate and a transmission assembly, the goods retrieval mechanism is connected to the transmission assembly to move along a length direction of the base plate under the drive of the transmission assembly, the goods retrieval mechanism comprises a rotating unit, a connecting base, and a goods retrieval unit, the goods retrieval unit is arranged on the connecting base, and the rotating unit is configured to drive the connecting base to rotate relative to the telescopic mechanism, so that the goods retrieval unit can take or place the goods container in different direction of the fork apparatus.

2. The robot according to claim 1, wherein the goods retrieval unit comprises a mounting plate and a plurality of suction cups, the mounting plate is connected to the connecting base, the mounting plate is vertically arranged, and the plurality of suction cups are arranged in an array on the mounting plate, or, wherein the goods retrieval unit comprises a mounting plate and an insert plate, the insert plate is arranged on the mounting plate, the insert plate is movable relative to the mounting plate, and the insert plate is insertable into a handle groove of the goods container.

3. The robot according to claim 1, wherein the telescopic mechanism further comprises a telescopic plate, the telescopic plate and the base plate are arranged to move relative to each other, the transmission assembly is arranged between the telescopic plate and the base plate, the goods retrieval mechanism is arranged on the telescopic plate, and in operation of the transmission assembly, the goods retrieval mechanism is configured to drive the telescopic plate to stretch bidirectionally relative to the base plate along the length direction of the base plate.

4. The robot according to claim 3, wherein the fork apparatus further comprises a locking mechanism, the transmission assembly comprises a flexible transmission member and a transmission wheel set, the transmission wheel set comprises a plurality of transmission wheels, the plurality of transmission wheels are respectively located on the base plate and the telescopic plate, and the flexible transmission member is wrapped around the plurality of transmission wheels, and is configured to move with rotation of the transmission wheel; and
the locking mechanism is arranged between the base plate and the telescopic plate, and when the locking mechanism is unlocked, the transmission wheels are configured to drive the base plate and the telescopic plate to move relative to each other under the drive of the flexible transmission member.

5. The robot according to claim 4, wherein the fork apparatus further comprises a sliding plate slidably arranged on the telescopic plate, and the goods retrieval mechanism is connected to the sliding plate; and
the sliding plate is connected to the flexible transmission member and is configured to move with the flexible transmission member.

6. The robot according to claim 5, wherein each of the transmission wheels on the telescopic plate has a variable relative position relative to each of the transmission wheels on the base plate, so that the flexible transmission member can drive the telescopic plate to stretch or retract relative to the base plate during the movement.

7. The robot according to claim 6, wherein the plurality of transmission wheels comprise two transmission wheel sets arranged symmetrically, each of the transmission wheel sets comprises a first transmission wheel, a second transmission wheel, and a third transmission wheel, the first transmission wheel and the second transmission wheel are arranged on the telescopic plate, the third transmission wheel is arranged on the base plate, and the first transmission wheel and the third transmission wheel have different positions in a movement direction of the telescopic plate; and
a flexible transmission belt is wrapped around the first transmission wheel and the third transmission wheel in the two transmission wheel sets, to form a closed ring, and the second transmission wheels in the two transmission wheel sets are both located outside the closed ring.

8. The robot according to claim 7, wherein the telescopic plate and the base plate extend along a same direction, two ends of the telescopic plate are each provided with an abutting portion, and when the sliding plate abuts against the abutting portion, the flexible transmission member is configured to push the telescopic plate to move through the sliding plate.

9. The robot according to claim 7, wherein the two transmission wheel sets are symmetrically distributed along a movement direction of the telescopic plate, and a spacing between two second transmission wheels in the two transmission wheel sets is less than a spacing between two first transmission wheels.

10. The robot according to claim 7, wherein in operation of the flexible transmission member in a first direction, the telescopic plate is configured to stretch from a first end of the base plate, or the telescopic plate is configured to retract from a second end of the base plate; and
in operation of the flexible transmission member in a second direction, the telescopic plate is configured to stretch from the second end of the base plate, or the telescopic plate is configured to retract from the first end of the base plate.

11. The robot according to claim 5, wherein the transmission assembly further comprises a first driving unit, and the first driving unit is connected to the transmission wheel and configured to drive the transmission wheel to rotate.

12. The robot according to claim 11, wherein two telescopic mechanisms are arranged, the fork apparatus further comprises a tray, a connecting bracket, and a transmission shaft, the two telescopic mechanisms are distributed on two opposite sides of the tray, telescopic plates of the two telescopic mechanisms are respectively connected to the two sides of the tray, base plates of the two telescopic mechanisms are connected through the connecting bracket, two ends of the sliding plate are respectively slidably connected to the telescopic plates of the two telescopic mechanisms, the first driving unit is arranged between the two telescopic mechanisms, an output end of the first driving unit is connected to the transmission shaft, and two ends of the transmission shaft are respectively connected to the transmission wheels of the two telescopic mechanisms.

13. The robot according to claim 4, wherein the locking mechanism is arranged on the base plate, the locking mechanism comprises a locking member, the telescopic plate is provided with a positioning groove, and the locking member is insertable into the positioning groove or detachable from the positioning groove, to lock or unlock the telescopic plate and the base plate.

14. The robot according to claim 13, wherein the locking mechanism further comprises a first elastic member, the locking member is slidably arranged on the base plate, the locking member is provided with a hanging pin, a first end of the first elastic member is connected to the hanging pin, a second end of the first elastic member is connected to the base plate, and the first elastic member is configured to apply an elastic force toward the positioning groove to the locking member.

15. The robot according to claim 14, wherein the locking mechanism further comprises a second driving unit, an output end of the second driving unit is provided with a rocker arm, the second driving unit is configured to drive the rocker arm to rotate, the locking member is provided with a stop pin, when the rocker arm is in a first position, the rocker arm is configured to abut against the stop pin to disengage the locking member from the positioning groove, when the rocker arm is in a second position, the rocker arm is detached from the stop pin, and the locking member is engaged with the positioning groove under the elastic force of the first elastic member.

16. The robot according to claim 4, wherein the fork apparatus further comprises a reset mechanism, the reset mechanism comprises a reset baffle, a second elastic member, and a third elastic member, the reset baffle is connected to the base plate, the second elastic member and the third elastic member are both arranged on the telescopic plate, the second elastic member and the third elastic member are both configured to abut against the reset baffle, and when the telescopic plate stretches relative to the base plate, one of the second elastic member and the third elastic member is configured to apply an elastic force toward the retraction direction of the telescopic plate to the telescopic plate;
wherein the reset mechanism further comprises a guide shaft, the guide shaft is arranged on the telescopic plate, the guide shaft is configured to extend along the stretching or retraction direction of the telescopic plate, the second elastic member and the third elastic member are both sleeved on the guide shaft and arranged along an extension direction of the guide shaft, and the reset baffle is located between the second elastic member and the third elastic member.

17. The robot according to claim 5, wherein the fork apparatus further comprises a detection assembly, the detection assembly comprises a controller, a sensing plate, and two first detection units, the first detection units are both arranged on the sliding plate, each of the first detection units is electrically connected to the controller, the sensing plate is arranged on the telescopic plate, the sensing plate is configured to extend along the length direction of the telescopic plate, the first detection unit is configured to feed back a detection signal when being opposite to the sensing plate, and the controller is configured to determine a position of the sliding plate relative to the telescopic plate based on the detection signal.

18. The robot according to claim 17, wherein the sensing plate comprises a first sensing section and two second sensing sections respectively connected to two opposite ends of the first sensing section, the first sensing section is configured to pass through a midpoint of the sensing plate in the length direction, and the two second sensing sections are arranged in a staggered manner relative to a width direction of the telescopic plate; and
the two first detection units are arranged in a staggered manner in the width direction of the telescopic plate, so that one of the two first detection units is opposite to the second sensing section or both of the two first detection units are opposite to the first sensing section when the sliding plate moves.

19. The robot according to claim 1, further comprising at least two second detection units, wherein the at least two second detection units are respectively arranged on two ends of the fork apparatus, to detect the goods container in a different goods retrieval or storage direction of the fork apparatus.

20. A warehousing system, comprising a shelving unit and the robot according to claim 1, wherein a plurality of shelving units are arranged, the plurality of shelving units are arranged at intervals, an aisle is arranged between adjacent shelving units, a width of the aisle is configured to match a width of the robot, the robot is configured to move in the aisle, and the fork apparatus of the robot is stretchable bidirectionally along a width direction of the aisle, to take or place a goods container on each of the shelving units on two sides of the aisle.
